(19) United States
(12) Patent Application Publication
(10) Pub. No.: US 2021/0272472 A1
(43) Pub. Date: Sep. 2, 2021

(54) System And Method For Tracking, Rewarding, Assisting The Cognitive Well Being, Emotional Well Being And Commitment Of A Student Including An Alert Component Which Automates Parent-Teacher-Counselor Communication

(71) Applicant: ED Trac, LLC, Manhattan Beach, CA (US)

(72) Inventors: Erin H. Sibley, Manhattan Beach, CA (US); Ma Secundila S. Tadena, Gardena, CA (US)

(21) Appl. No.: 17/175,624

(22) Filed: Feb. 13, 2021

Related U.S. Application Data
(60) Provisional application No. 62/982,120, filed on Feb. 27, 2020.

(51) Int. Cl. G09B 19/00; G06Q 50/20; G06Q 10/10; G09B 7/00

(52) U.S. Cl. CPC G09B 19/00; G06Q 50/205; G06N 20/00; G09B 7/00; G06Q 10/1095

(57) ABSTRACT

A method of evaluating a student includes determining an academic, behavior and commitment indicators and comparing the indicators to previous indicators. The method further includes communicating an academic badge signal to a student device when comparing the academic performance indicator to a previous indicator is positive. When academic comparison is negative, communicating an academic resource recommendation signal to a student and an academic alert signal to a teacher device or a parent device. When behavioral is negative, communicating a report signal to a teacher device, administrator device or counselor device. When the commitment performance indicator is positive, generating a commitment badge signal and communicating the commitment badge signal to the student device. When comparing the commitment performance indicator corresponds to a negative commitment performance, communicating a commitment resource recommendation signal to the student device and a commitment alert signal to a teacher device and a parent device.

### CROSS-REFERENCE TO RELATED APPLICATION

This application claims the benefit of U.S. Provisional Application No. 62/982,120, filed on Feb. 27, 2020. The entire disclosure of the above application is incorporated herein by reference.

### FIELD

The present disclosure relates generally to a system for monitoring the progress of a student and, more particularly, to a system and method for tracking, rewarding and assisting a student in academics, behavior and commitment and alerting parents and school employees.

### BACKGROUND

School systems use various tools to interface with a student and teacher. Some programs such as POWERSCHOOL® provide tools to allow students and parents to monitor the grade history, attendance history and provide school information. Such systems do not typically provide any type of monitoring of a student on an automatic basis. That is, there is no provision for encouraging a student's positive behavior. Also, there is no provision for alerting parents or teachers of negative behavior.

Academics is an important aspect of school. Grades are a reflection of learning certain concepts. The concepts to be learned in school may be regulated under the common core curriculum. However, besides the actual grades themselves, there is little monitoring of motivation. In addition, no integration of prior known systems is available or exists to make a teacher jobs more efficient. The same lack of integrated systems makes it difficult for students to self-monitor their performance. Certainly, such prior systems are not known to provide incentives to perform.

Another drawback of prior known systems is the ability to track negative behavior. When grades trend downward, unless an administrator or parent happens to notice, nothing is initiated. Grades are only one indicator. Students have many other outsides influences that may affect their performance in school and therefore affect the grades. However, monitoring such influences is also not previously known absent a teacher noticing an issue.

### SUMMARY

The present disclosure provides a method for monitoring the academic, behavioral and commitment level of a student. This allows changes in various behaviors to be monitored by parents, teachers and administrators to provide warnings when the performance is low. Further, the system provides incentives to continually improve.

In one aspect of the disclosure, a method of evaluating a student includes determining an academic performance indicator, determining a behavioral performance indicator, determining a commitment performance indicator, and comparing the academic performance indicators to a the previous academic period performance indicator. The method further includes, when the step of comparing academic performance corresponds to a positive academic performance, generating an academic badge signal and communicating the academic badge signal to a student device along with communicating challenging resource recommendations. When the step of comparing academic performance corresponds to a negative academic performance, communicating an academic resource recommendation signal to the student device and communicating an academic alert signal to at least one of a teacher device and a parent device. When the behavioral performance indicator corresponds to negative behavioral performance, communicating a report signal to at least one of a teacher device, an administrator device and a counselor device. The method compares the commitment performance indicator to a previous commitment performance indicator. When the step of comparing the commitment performance indicator corresponds to a positive commitment performance, generating a commitment badge signal and communicating the commitment badge signal to the student device. When the step of comparing the commitment performance indicator corresponds to a negative commitment performance, communicating a commitment resource recommendation signal to the student device and a commitment alert signal to a teacher device and a parent device.

In a further aspect of the disclosure, a method of evaluating a student includes determining an academic performance indicator, determining a behavioral performance indicator, determining a commitment performance indicator, and when the academic performance indicator, the behavioral performance indicator or the commitment performance indicator is negative communicating an alert signal to at least one of a teacher device and a parent device, initiating a conversation with a chatbot or collaborative filtering of high performing and low performing students such that students are able to communicate, interact and learn from each other. In a further aspect of the disclosure, the alert system automatically schedules parent-teacher/counselor conferences when negative academic and or commitment performance indicators are determined.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high-level block diagrammatic view of the entire system.

FIG. 2 is a block diagrammatic view of the controller of the system of FIG. 1.

FIG. 3 is a block diagrammatic view of the academic learning circuit of FIG. 2.

FIG. 4 is a block diagrammatic view of the behavior circuit of FIG. 2.

FIG. 5 is a block diagrammatic view of the commitment circuit of FIG. 2.

FIG. 6 is a flowchart of a high level method of operating the system.

FIG. 7 is a flowchart of a method for determining a baseline for a student.

FIG. 8 is a flowchart for determining an academic performance indicator.

FIG. 9 is a flowchart of a method for determining a performance badge.

FIG. 10 is a flowchart of a method for generating an improvement badge.

FIG. 11 is a flowchart of a method for performing an alert.

FIG. 12 is a flowchart of a method for determining a behavior performance indicated.

FIG. 13 is a flowchart of a method for determining a commitment score.

FIG. 14 is of an example rubric for determining a commitment score.

FIG. 15 is a flowchart of a method for determining a composite reward.

FIG. 16 is a screen display for notification to a guardian for setting up a conference.

FIG. 17 is an example of a screen display for notifying a student.

FIG. 18 is a screen display for notifying a student of a reward.

FIG. 19 is a screen display of a chatbot.

FIG. 20 is a screen display for showing student performance in each of the three performance indicators.

FIG. 21 is a screen display for a recommendation.

FIG. 22 is a screen display for a welcome screen.

FIG. 23 is a screen display showing an example of performance of a system.

Corresponding reference numerals indicate corresponding parts throughout the several views of the drawings.

### DETAILED DESCRIPTION

Example embodiments will now be described more fully with reference to the accompanying drawings.

The following description is set forth with respect to students, parents, teachers, counselors and districts to provide new ways to encourage students in academics, monitor behavior and encourage the student in commitment.

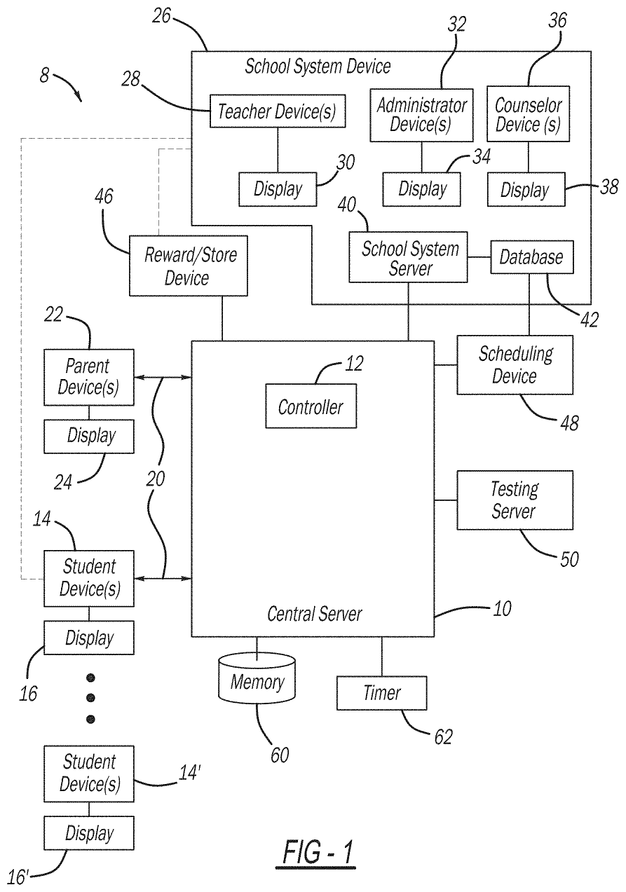

Referring now to FIG. 1, a system 8 includes a central server 10 that is used for the basis of the system. For convenience, the central server 10 is illustrated as a single component. However, the central server 10 may be a physical server or a plurality of physical servers that are linked. The server 10 may also be distributed in various locations including the school system.

The central server 10 has a microprocessor-based or discrete circuitry controller 12 that is programmed to perform a number of functions, the details of which will be provided below. Of course, many controllers may be included in many servers. The controller 12 may use artificial intelligence, expert systems, programming logic and discrete circuitry for making the decisions associated with the process.

A student device 14 is coupled to or includes a display 16. The student device 14 represents one of a plurality of student devices used in a system. The student devices, as will be described in more detail below, run a computer software application or app that is used to interface with the central server 10 through a network 20. The computer application is software that is programmed to perform various functions as will be described in greater detail below. The student device 14 may be but is not limited to a fixed device such as a desktop computer or a mobile device, such as a cellular phone, tablet computer, wearable device or laptop computer. Other types of student devices may be used including a desktop computer. Student device 14 may also be in communication/collaborate with one or more student devices 14′ with an associated display 16′ based on student collaborative filtering results. For example, high performing students for a subject matter may be linked with lower performing students for the subject matter.

One or more parent devices 22 may also be in communication with the central server 10. The parent devices 22 also are in communication with a display 24. The parent devices 22 may be one of the fixed or mobile devices mentioned relative to the student device 14. The parent devices 22 also use the computer app or software that is programmed to perform various functions. The distinguishing feature between the parent devices and the student device 14 is the log in or authentication will provide different information to the users through the display 24.

A school system device 26 is also in communication with the central server 10 through the network 20. The school system device 26 is a plurality of devices such as a teacher device 28 associated with a display 30, an administer device 32 associated with the display 34 and a counselor device 36 associated with a display 38. The school system device 26 may also include a school system server 40 that is in communication with a database 42. The school system server 40 and database 42 may be used for other functions and may be preexisting prior to installing the present system according to the disclosure. The central server 10 may communicate directly with the school system device 26 or may communicate indirectly with through the school system server 40.

A reward or store device 46 is coupled to the central server 10. The reward or store device 46 may itself be a server that receives communications from the central server 10 to indicate that a student has achieved a reward. The communications are a purchase reward signal. The student associated with the student device 14 may therefore select merchandise in person or on-line. The reward or store device 46 may be associated with a school system such as a school store. The reward/store device 46 may also be an external physical or electronic retailer. The reward or store device 46 may receive an indication for a reward and issue a gift certificate, the record of which is stored within the reward or store device 46. The reward or store device 46 may then communicate directly or indirectly through the central server 10 with the student device 14. The student device 14 may receive an email, link or other notification that a reward has been issued. The student device 14 may then redeem the gift certificate or reward at the reward/store device 46. A scheduling device 48 is coupled to the central server 10. The alert scheduling server 48 may be a server that receives signals to set appointments with teachers, counselors and parents. The scheduling device 48 may be associated with or within the school system device 26 The scheduling device 48 may communicate directly or indirectly through the central server 10 with the parent device 22.

A testing server 50, which is external to the central server 10, may also be in communication with the central server 10. The testing server 50 may generate or perform testing with student devices 14 through the central server. The testing server 50 may determine a learner type. The learner type may be determined using a multi-intelligence test or another type of psychological assessment with results. The learner type may, by way of example, include but is not limited to visual, musical/artistic, motions/kinetics, and logical/mathematical. Another test may determine the emotional stability of the student.

The central server 10 may also include a memory 60 that stores various data from the school system devices, the student devices and the parent devices for later retrieval. The memory 60 may, for example, store a student profile that includes the learner type, grades, badges, emails or other notification signals. The central server 10 may store a database in the memory 60.

A timer 62 may also be associated with the central server 10. The timer may provide the time of day and also be used to determine relative times over which to measure performance. The time of day may be used for a time stamp.

In general, the central server 10 performs a method for assisting students with academic, behavior and commitment matters to allow each student to grow in the three areas. The system helps parents to monitor the performance of the students. In today's world, multiple responsibilities for parents often overwhelm the parents and therefore the schooling of their children is less of a priority. Performance indicators are provided to the parents, as will be described in more detail below, from the central server 10 to allow them a supportive role with key aspects of the child's well-being. In addition, as will be described more below, the central server 10 allows parent-teacher-counselor communication to be automated so that teachers can more easily schedule a conference.

The school system device 26 may be associated with a school district and used communicate with central server 10 to track the performance of the students in the school district. School districts are often require to comply with various federal and state mandates when receiving technology grants such as laptops and tablet computers. The central server 10 provides a system that satisfies state and federal monitoring of behavior of the students. The school device 26 may provide the central server 10 with various weights for the various parameters provided by the central server 10. This will be described in greater detail below. The system 8 and the central server 10 associated with the system allows summary data or data reports in the various areas for the various students to be generated. Groups of students such as school level or grade level may also be generated to assist the administrators within the school district. The usage time of the system may be tracked within a district and compared to students outside of the district using various demographics, size or the like. This will allow the state or federal government to allocate resources where needed.

Counselors may use the system 8 to track the performance of at-risk students. By tracking the behavior, the counselors are provided a tool in which they may address situations before severe changes have occurred. Truancy, tardiness, absenteeism and the digital footprint of students may track behavior trends and communicate an alert signal alert to the counselor to a negative trigger occurring. Preventative actions may occur prior to having to perform reactive measures. The counselors may also use the system to collaborate with teachers and parents to prevent behavior from becoming too severe. Because of the time savings, counselors may be allowed to concentrate on more severe cases and prevent marginal cases from becoming more severe. Students, in the case of truancy or abhor engagement, may be addressed by a chatbot as will be described below. When things become severe, an automated parent-teacher-counselor conference may be initiated at the request of the central server 10.

Teachers learn the learner type and motivation type of the students and can monitor the performance level of the student through performance indicators. Teachers may then differentiate and personalize various teaching techniques for the students. Also by providing on-line or on-site teacher conferences, poor performance can be easily addressed.

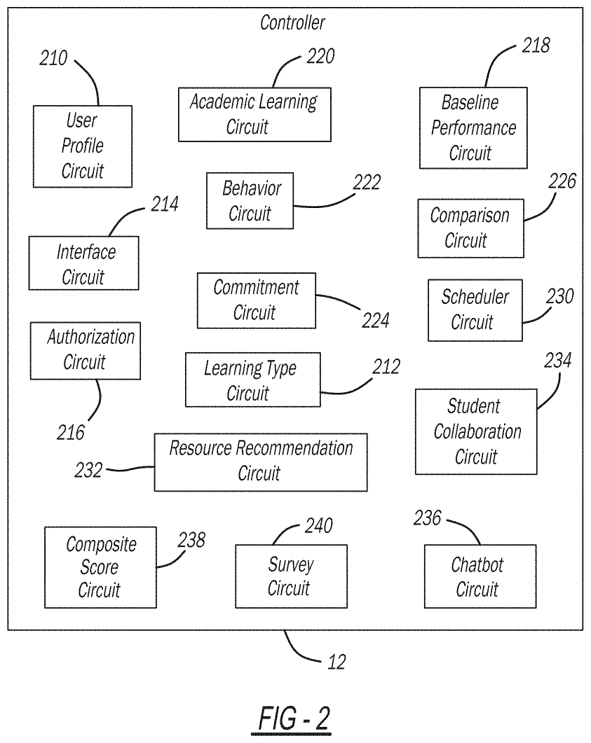

Referring now to FIG. 2, the controller 12 of the central server is illustrated in further detail. The controller 12 has a plurality of circuits that may be analog circuits, digital circuits and microprocessor based circuits that are programmed to perform various functions. In this example, a user profile circuit 210 is used to obtain a user profile from the various users. The user profile circuit 210 may be used to obtain a profile of not only a student user but a parent user and a school system user such as a teacher, administrator or a counselor. The user profile circuit 210 may, for example, be accessed when the application is stored and a login is provided. For students the profile may be extensive. For administrators, teachers and parents the profiles may be merely login information and the association with a student or groups of students. The school system may provide a code to a user and, thereafter, the code may be used to validate the user. The user profile circuit 210 may obtain various information such as name, grade level, school name and district name. The codes may be provided through the school administrator and associated with the initialization code provided to the student. The user profile circuit 210 may allow each of the devices to establish a login, a user name and password if is not provided by the district. The user profile circuit 210 may interface with other circuits within the controller 12. For example, the learner type circuit 212 may initiate a learner type test from the testing server 150 described above. The learner type circuit 212 may perform this test by providing various queries to the user profile circuit 210, which, in turn, communicates the queries to the student device through the network 20. The learner type circuit 212 establishes the learner type and motivation type of the student in response to the various queries.

An interface circuit 214 allows the controller 12 to communicate through the network 20. The interface circuit 214 formats the communications in the appropriate manner for the network such as using an internet protocol. The network 20 may be wired, wireless or satellite or combinations thereof. Mobile devices may for example communicate over Wi-Fi or cellular networks or combinations of both.

The user profile circuit 210 also allows the parent to establish login credentials such as a user name and password. Likewise, the teacher devices 28, the administrator devices 32 and the counselor devices 36 may also be provided with the means to establish a user name and password. The parent devices 22 are associated with the student devices 14 through interaction with the central server. Likewise, the teacher devices 28 may also be associated with students and the parents of students. Administrator devices 32 may be associated with all of the students within a particular school or an entire school district. Counselor devices 36 may be associated with student devices 14 and parent devices 22 under their school relationship. The associations of the various devices are controlled through the central server 10 and stored within the memory 60 such as in a database of the memory 60. The authentication circuit allows the various user devices to be authenticated during the operation of the system.

A baseline performance indicator circuit 218 is used to obtain a baseline of a student. The baseline performance indicator circuit 218 may obtain information data such as grades, either through the district or through external services that the district already uses, such as POWERSCHOOL®, Illuminate®, Google®, Schoology®, and Canvas®. The baseline includes the student's name and ID, age, grade level, various email accounts associated with the student, the learner type, and the motivation type. The learner type circuit 212 may also communicate with the baseline performance indicator 218 to provide the type of learner for the student in the baseline. The baseline performance indicator circuit 218 may also obtain the user's habits, state and local exam results, digital footprints, and data results of a questionnaire to obtain the baseline for the user profile. This will be described in more detail below. Ultimately, the baseline performance circuit 218 analyzes the data to obtain a baseline for the academic learning circuit 220, the behavior circuit 222 and the commitment circuit 224. Ultimately, each of the circuits 220, 222, 224 have outputs that are compared in a comparison circuit 226. The comparison circuit, 226 as will be described in more detail below, compares the behavioral baseline initially and previous results from each of the academic learning circuit 220, the behavior circuit 222 and the commitment circuit 224 to determine whether the student has a positive academic performance, a positive commitment performance, a negative academic performance, a negative behavioral performance or a negative commitment performance (or combinations thereof). Details of this will be described in greater detail below. Ultimately, the controller 12, based on the comparisons, may employ a scheduler circuit 230 that is used to schedule a conference between a teacher, counselor or administrator and the parent based upon the comparison. A resource recommendation circuit 232 is used to recommend resources or programming to the student based at least on the student profile to assist in learning a subject matter. A student collaboration circuit 234 is used for allowing or pairing students to team together for a particular subject matter. A collaboration signal from the student collaboration circuit 234 may link one or more high performing students with one or more underperforming students for the particular subject matter. A chatbot circuit 236 is used for initiating an on-line textual chat conversation with an automated processing system to collect information and encourage a particular behavior in the students.

A composite score circuit 238 is used for generating a composite score based on the academic performance indicator, the behavioral performance indicator and the commitment performance indicator. The composite score circuit 238 may weigh the indictors differently in the composite score determination. The composite score circuit 238 generates or causes the generation of a screen display in response to the composite score communicated to the student device 14, parent device 22, the teacher device 28, the administrator device 32 and/or the counselor device 36.

A survey circuit 240 is disposed in the controller 12. The survey circuit 240 generates a survey signal that may be communicated to the different devices (student, parent, school system) to obtain feedback to adjust various matters. For example, after a survey signal is communicated to a student device, a survey results signal may provide feedback to provide feedback as to the recommend resources. That is, a resource may be moved up or down a recommended resource list based on the feedback (or removed all together). Parent devices may provide a survey results signal corresponding to the operation of the system, the types of resources and the like. The same type of survey may be used to query the teacher devices or the counselor devices regarding the effect of the recommendations on a student or how the system operates.

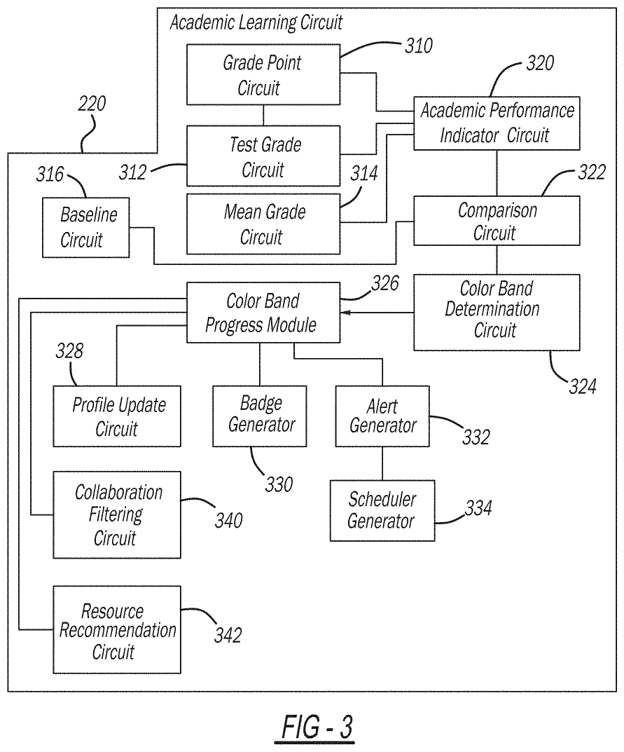

Referring now to FIG. 3, the academic learning circuit 220 from FIG. 2 is illustrated in further detail. In the academic learning circuit 220, a grade point circuit 310, a test grade circuit 312 and a mean grade circuit 314 obtains the current grade point, test grades and determines a mean grade from various sources including external sources such as Schoology®, Illuminate®, PowerSchool® or the district's own servers. A baseline circuit 316 receives the academic learning baseline based upon the determination of baseline performance indicator circuit 218. Ultimately, an academic performance indicator is determined from the grade point 310, the test grade circuit 312 and the mean grade circuit 314. The academic performance indicator circuit 320 provides an output signal to the comparison circuit 322. The comparison circuit 322 compares the baseline from the baseline circuit 316 to the academic performance indicator circuit 320. This is an initial assessment. Once the academic performance indicator is determined on an ongoing basis, the comparison circuit compares a previous academics performance indicator with the current academics performance indicator. Based upon whether the academic performance indicator indicates a positive academic performance or a negative academic performance, a color band determination circuit 324 generates a color band or other type of signal that corresponds to the progress being made. A color band progress module 326 determines a trend. Ultimately, a performance indicator threshold may be used in the comparison to determine whether progress is being made or positive academic performance is being achieved or whether a negative academic performance is being achieved. Ultimately, the change in the academic performance indicator is communicated to a profile update circuit 328 so that profile is updated with the current academic performance.

A badge generator 330 generates a badge signal and communicates the badge signal to the student device when the academic performance is positive. The academic badge signal may then be displayed at the student device. The badge generator 330 may also communicate the badge to the school system device and to other devices, such as the parent device. The color band progress module 326 may also be in communication with an alert generator 332 that generates an academic alert signal communicated to the school system and potentially to a parent. The alert generator 332 may provide a request to schedule a conference at the schedule generator 334. In one example, the alert generator 332 may be generate the academic alert signal as an email or text signal that includes a link to schedule a conference at an appropriate time based upon the schedules of the teacher, counselor and student.

The color band progress module 326 also provides an academic performance signal to a collaborative filtering circuit 340. The collaborative filtering circuit 340 may provide a collaboration signal suggestion for contacting somebody that may help a student such as another student that is strong in the subject matter in which the current student is struggling. An email or text link may be used in the situation. On screen notification through the app may also be provided. The color band progress module 326 also is in communication with a resource recommendation circuit 342. A resource recommendation circuit 342 may suggest various programming resources such as computer applications or programs as well as videos to assist the student in mastering the subject matter. The resource recommendation circuit 342 generates at least one of an academic resource recommendation signal, a behavior resource recommendation signal and a commitment resource recommendation signal. The resource recommendation circuit 342 also takes into consideration the learning type in determining a resource for assisting the student to improve. Alongside the resource recommendation circuit 342, random survey pop-ups in the app from the survey circuit 240 may be used to assess the quality of the recommended programming. That is, the feedback from the survey may be used to adjust the recommend resources.

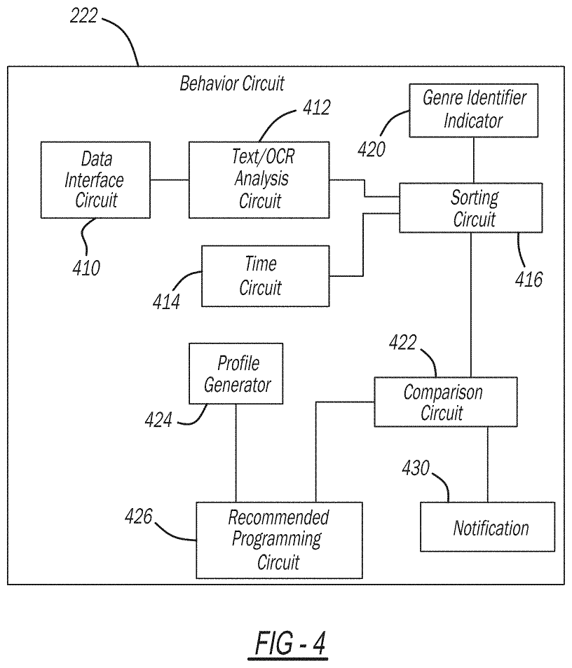

Referring now to FIG. 4, the behavior circuit 222 of FIG. 2 is illustrated in further detail. The behavior circuit 222 has a data interface circuit 410 that obtains data from various resources. Attendance data may be obtained from systems used by the school system and stored within the school system server or externally. The data interface circuit may, for example, retrieve attendance data, tardiness data and the like from a school computer. The data interface circuit 410 may also monitor the students' activity when interacting with electronic devices. A text/OCR analysis circuit 412 uses a timestamped circuit 414 to time stamp the relative time that each of the system was used. The time stamp circuit 414 may therefore allow a sorting circuit 416 to sort time stamped identifier in terms of corresponding to a school in session time versus after school sessions. A genre identifier circuit 420 identifies the genre of the text from the analysis circuit 412. The sorting circuit 416 ultimately generates a behavioral performance indicator that is compared to a previous behavioral performance indicator to determine whether the activity corresponds to a negative behavioral performance. Comparison circuit 422 ultimately determines a behavior performance indicator that is compared to the baseline at the initial use of the system or to a previous behavioral performance indicator to determine whether the activity is unusual. Non-educational searches during school hours or later night hours have a higher activity level. Unusual searches such as searches for various types of genres will also be flagged negatively and be incorporated into the behavior performance indicator. A profile circuit 424 uses the user profile and, in particular, the learner type age and grade level to determine recommended programming at the recommended programming circuit 426. Alongside the resource recommendation circuit 426, random surveys pop-up in the app from the survey circuit 240 may be used to assess the quality of the recommended programming. A notification circuit 430 in communication with the comparison circuit 422 may notify parents and the teacher as well as administrators or counselors of specific behavior flagged as severe. Severe behavior may include searches for illicit substances, weapons or the like. Of course, the various levels of severity may be judged according to input from the school distance and therefore weighted accordingly.

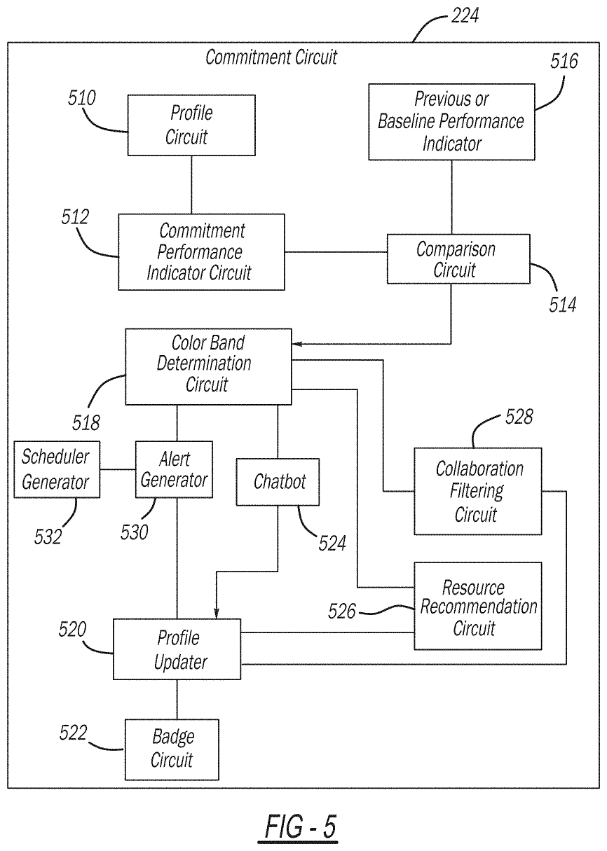

Referring now to FIG. 5, the commitment circuit 224 illustrated in FIG. 2 is set forth in further detail. The commitment circuit 224 obtains the user profile at the profile circuit 510. The user profile is obtained directly from the user profile circuit 210 and is illustrated in FIG. 5 redundantly. The profile circuit 510 communicates with a commitment performance indicator circuit 512. The commitment performance indicator circuit obtains commitment data to determine a performance indicator. The commitment performance indicator may take into consideration many things including attendance, citizenship, the determination of whether assignments have been late, the amount of engagement with the recommended academic assignment provided by the system and other types of academic activities. Descriptions of this will be provided in more detail below. A comparison circuit 514 receives the commitment performance indicator. The comparison circuit 514 receives a previous or baseline indicator from the profile circuit or from the memory from the updated profile. The previous or baseline performance indicator 516 is compared to the current commitment performance indicator to determine a commitment indicator or a commitment score. Color bands are commonly used in academic settings and are used for the commitment scores. A color band determination circuit 518 determines a color band when the color band corresponds to a positive commitment performance based upon the color band. The profile updater 520 updates the profile and generates a badge signal that is communicated to the student device and may also communicate a badge signal to a school district device or the parent device as well at 522. A negative commitment performance indicator may be provided when the color level is unfavorable. In this example, there are two unfavorable conditions. The first is when a drastic change is determined by the comparison circuit 514. An alert signal is generated and communicated to one or more of the school devices and the parent device. The second negative commitment performance indicator is generated with a lesser change in the commitment performance. In the second case chatbot may be initiated in 524, a resource recommendation circuit 526 may provide recommended resources and thereafter the profile updater 520 may be used to update the profile. Likewise, a collaborative filtering circuit 528 may also be provided. The collaborative filtering circuit 528 and the resource recommendation circuit 526 correspond respectively to blocks 340, 342 set forth above. Alongside the resource recommendation circuit 526, a random survey pop-up in the app communicated from the survey circuit 240 may be used to assess the quality of the recommended programming. Therefore, these elements will not be described in further detail.

The color band determination circuit 518 may also be in communication with an alert generator 530 that generates a commitment alert signal communicated to the school system and potentially to a parent. The alert generator 530 may provide a request to schedule a conference at the schedule generator 532 (which may be the external scheduling device 49 of FIG. 1). In one example, the alert generator 532 generates the commitment alert signal as an email or text signal that includes a link to schedule a conference at an appropriate time based upon the schedules of the teacher, counselor and student as determined by the schedule generator 532.

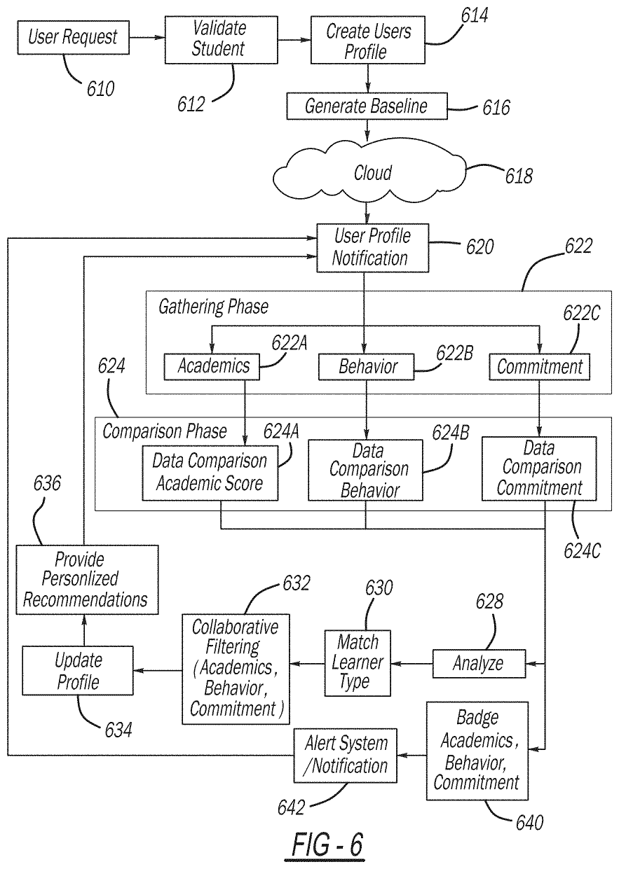

Referring to FIG. 6, a flowchart for the overall flow of the process is set forth. In step 610, the user generates a request to use the system. The user request 610 may be communicated to the central server 10. In step 612, the student is validated into the system. Should a parent or administrator desire data from the system, the parent or administrator may also be validated. In the following flowchart, the presumption is a student is accessing the system. In step 614, the user profile for the student is created. The user profile is created with a baseline 616. The baseline 616 refers to the academic, behavior and commitment baselines used to initiate the process. As time goes on, the user profile is updated with ongoing academic, behavior and commitment data. The user profile in block 614 is used for providing basic information such as the student identifier, name, a password and the like. In step 618, the data is communicated to and from the central served 10, which may be a cloud server 618. In step 620, the system has a notification that is performed to obtain a user profile. A gathering phase in step 622 gathers the data of the particular student. In block 622, the academic performance indicator is generated in 622A. The behavior performance indicator is generated at 622B and the commitment performance indicator at block 622C. The generation of the academic performance indicator, behavior performance indicator and commitment performance indicator will be described in more detail. In block 624, comparisons are performed from previous indicator data signals gathered, such as the baseline data signal obtained after the baseline was established. In step 624A, the academic performance indicator is compared with a previous academic performance indicator. As mentioned above, this may be baseline or a previously generated data. In block 624B, the behavior performance indicator determined in 622B is compared to a previous behavior performance indicator. In block 624C, the commitment performance indicator determined in step 622C is compared with a previous commitment indicator each of the comparison in step 624A-624C.

In step 628, the results are analyzed and the learner type is matched in step 630. In step 632, collaborative filter may take place for each of the categories of academics, behavior and commitment. The collaborative filtering was described briefly above and filters various types of programs for use. That is, various types of programs may assist the student in, for example, academics. In step 634, the collaborative filtering may also take place with students by allowing other students to assist students who are having issues with certain subject matters.

Referring back to step 640, when the results are positive in the comparisons performed in block 624, badges may be communicated to the user. Also, an alert signal may be generated and communicated to the administrator or parents of the student. An academic, behavior or commitment alert signal/notification (or combinations thereof) is generated in block 642. The alert signal may also be provided to the student and the school teachers on the screen display associated with the respective devices. A notification may also be provided. The notification may correspond to an event or another type of event. After block 642 and 634, the user profile is updated and notified in step 620. The system continually repeats on a regular basis such as weekly.

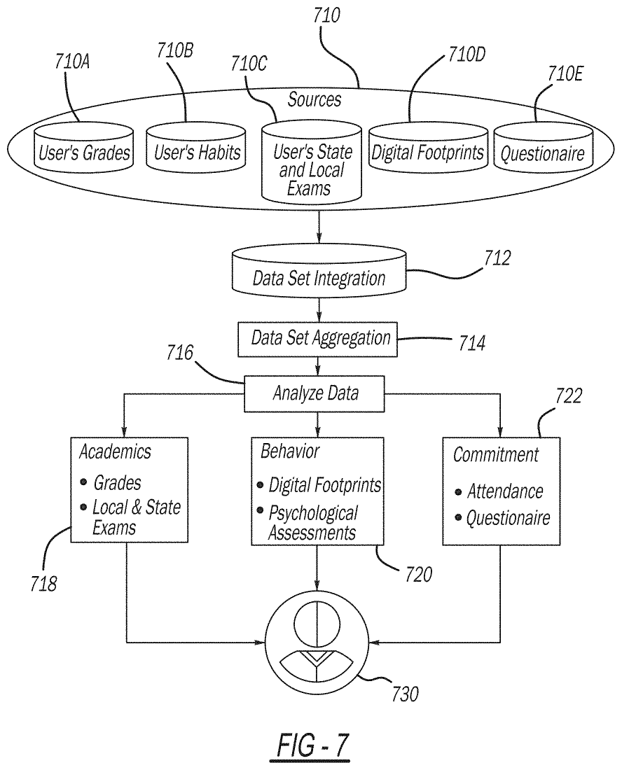

Referring now to FIG. 7, the baseline step 616 illustrated in FIG. 6 is described in further detail. Block 710 corresponds to a plurality of sources that are used to obtain a baseline for the student. Block 710A corresponds to the user's grades. Block 710B corresponds to the user's habit as monitored by usage data. Block 710C obtains the state and local exam of the user or student. Block 710D looks at the digital footprint of the user and the interaction with the browser and the internet. Optical character recognition as well as other types of data may be provided in the digital footprint. Academic sites, motivational sites and various online activity are monitored. A questionnaire 710E that is answered by the student may also be used in the baseline to determine the learner type. In step 712, the data is integrated at a data set integration block 712. The data is then aggregated in block 714. The data is analyzed in block 716 to determine a baseline for academics at block 718 for behavior in block 720 and for commitment at block 722. The academics block uses grades from the previous year, tests or evaluations, such as standardized test. The behavior step 720 uses both digital footprints and psychological assessment. Blocks 722 obtains attendance and reviews the questionnaire. Ultimately, the user profile 730 is generated so that comparisons can be made with future data that is obtained. It should be noted the psychological assessment performed for the behavior block provides results corresponding to the emotional stability of the student and not the developmental stability.

The academic database contains programming filtered by grade level standards, subject area and clustered by the learner type such as visual, musical/artistic, motions/kinetics, logical/mathematical. By using the academic database, personalized recommendations for content to improve the student may be achieved. The recommendation may comprises application or other program 9 outside tutoring) that are selected based on knowledge, the survey results the sender learning type, the content or the like.

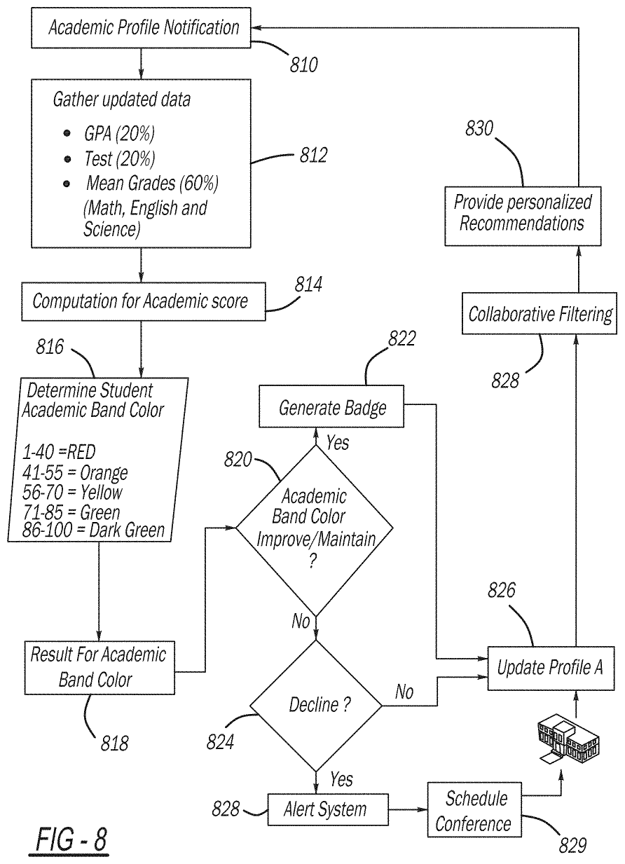

Referring now to FIG. 8, the determination of the academic performance indicator is performed. In step 810, an academic profile notification is received. The academic profile notification may take place periodically, such as weekly. Once the academic profile notification profile is received, an indication of the academic performance is obtained. In step 812, data is gathered such as the grade point average, test grades and mean grades. Various weights may be placed upon the various levels such as 20% for the grade point average, test grades 20% and the mean grades 60%. This allows the grades to be monitored over time without specific tests weighing too heavily. School districts or the like may have different desired weightings for each of the levels. In step 814, the academic score is computed as an academic performance indicator. In step 816, the academic performance indicator is compared to various band levels. The band levels for the academic score, in this example, are based upon colors. However, numerical or alphabetical indicators may also be provided. In this example, the academic performance indicated is compared to various thresholds. The colors associated with the academic performance are 0-40 for red, 41-55 for orange, 56-70 for yellow, 71-85 for green and 86-100 for dark green. Of course, the thresholds for each of the levels may be changed based upon the school district requirements. In step 818, the comparison of the academic performance indicator with the color ran thresholds results in an academic band color being determined in step 818. Thereafter, step 820 determines whether the color band indicates an improvement or the color level being maintained. In step 822, when the color level was maintained or improved in step 820, a badge signal is generated. The badge signal may be communicated to the student device, the parent device and one of the school system devices, such as the teacher device, administrator and/or the counselor device.

In step 820 when the color band is not maintained or improved, it is determined whether the system has declined in step 824. At step 824, if the student has not declined in academic performance, step 826 updates the profile accordingly. Step 826 is also performed after step 822. Referring back to step 824, when the student has declined in step 824, step 828 generates an academic alert signals to the school devices such as the teacher device, the administrator device and the counselor device as described above and thereafter step 826 is again performed to update the profile for the student. In step 829, a conference scheduler may initiate a conference between parents and teacher. The scheduling of a conference may take with a conference scheduling signal such as texts, an email an application notification or link to the parents. The conference scheduler may check available time slots for the teacher and propose several available times in the conference scheduling signal. The automated scheduling allows the student and parent to choose the convenient time without burdening the teachers with additional work. In step 826, collaborative filtering is performed. As mentioned above, collaborative filtering allows the recommendations to be generated based upon metadata for various types of learners. Personalized recommendations in step 830 may also be provided. Personalized recommendations allows the learner type to be coordinated with different recommendations to assist the student.

The personalized recommendations match the learner type and the subject area together with the grade level and similar coded programming. Programming may be provided within the database with metadata that corresponds to the particular subject matter and the content as the grade level and subject area may all be provided within the metadata. The particular subject matter that the student requires additional work is determined and the metadata matched. The likes and dislikes of the student is also considered in the collaborative filtering 828. The academic resource recommendation signal includes recommended programming in step 830 that is monitored over time using feedback to determine whether positive results and impacts on the grades are positive. As mentioned above, after step 830, the system repeats in step 810 so that weekly assessments are provided. Random surveys may also be used to assess the quality of the recommended programming to improve the quality of the service and the recommended resources.

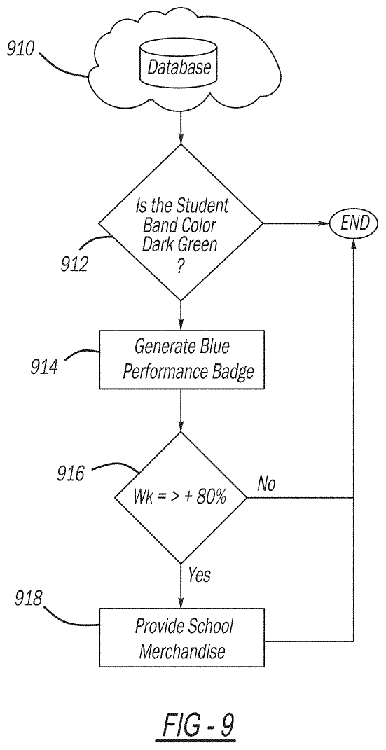

Referring now to FIG. 9, step 822 describes generating a badge signal with badge data (a badge). Different types of badge signals may be provided such as a performance badge signal and improvement badge signal. Each of the types of badges are communicated using badge signals that are communicated through the internet or other type of network to the appropriate devices, such as the student device.

Referring now to FIG. 9, step 822 generates a color band. A performance badge may be provided when the student achieves a dark green color band. In step 910, the database associated with the central server is used to retrieve the color band of the student. In step 912, if the band color is dark green, step 914 generates a blue performance badge. In step 916, when the number of badges is determined over a particular time, such as the semester and the number of blue badges earned is greater than 80%, a purchase signal may be generated in step 918. In this example, the purchase signal may be communicated to a merchant such as the school store or an external merchant so that the student may select particular merchandise as a reward for the outstanding performance.

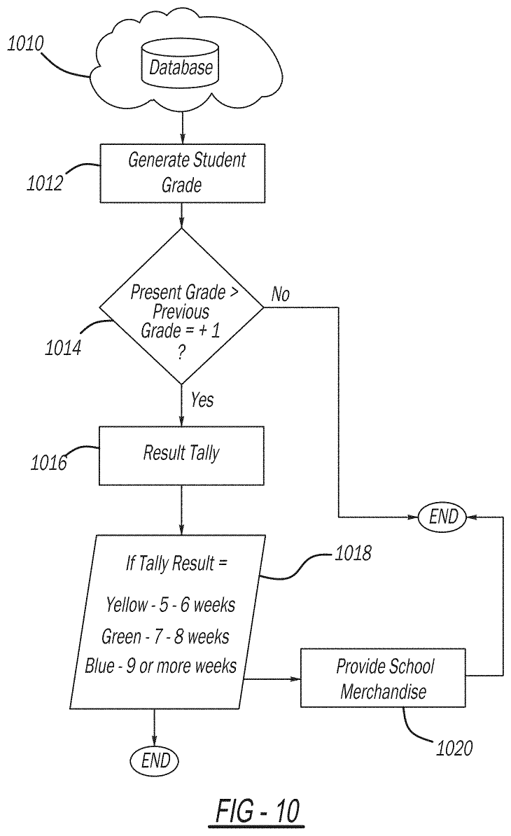

Referring now to FIG. 10, another type of badge that may be generated in step 822 is an improvement badge. In step 1010, data from the database corresponding to the student is generated. In step 1012, when the present grade is greater than the previous grade, in step 1014, a tally is determined in step 1016. The tally results are compared in the comparison 1018. When the tally corresponds to 5 or 6 weeks, a yellow performance badge is provided. When the results tally to between 7 and 8 weeks, a green performance badge is provided. When the results tally greater than 9, indicating 9 or more weeks, a blue improvement badge is provided. Of course, the colors and the number of weeks are merely representative of example data for consideration. School systems and the like may change the various thresholds and weights. Different levels of merchandise may be purchased based upon yellow, green or blue improvement badges. In step 1020, the improvement badge signal may be communicated to various retailers such as the school store so that merchandise may be purchased

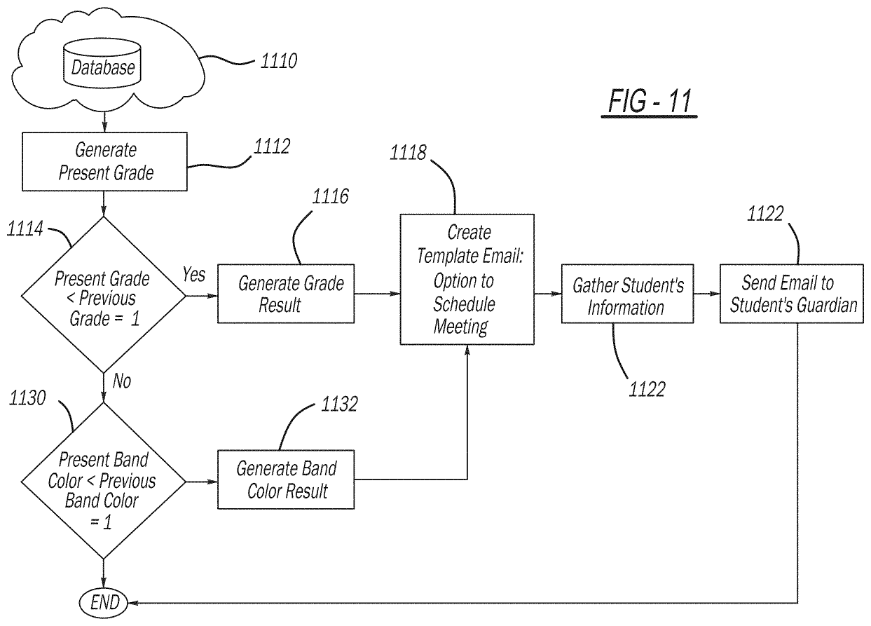

Referring now to FIG. 11, the alert system 828 is illustrated in further detail. In step 1110, the database is used to retrieve various data when the performance indicator is declined below a threshold. Both a sudden drop and a continuous decline are determined in the method for determining an alert signal. The present grade for a student is retrieved from the database in step 1112. In step 1114, when the present grade is less than a previous grade, step 1116 generates a grade result signal. In step 1118, an email option may be provided to schedule an email. The email may include the data corresponding to the drop in the student's information. In step 1122, the email may be generated and communicated to the student's guardian or parent.

When the present grade is not less than the previous grade, step 1130 determines whether the color band is less than the previous color band. When the present color band is less than the previous color band, color band result is generated in step 1132. Thereafter, steps 1118-1122 are again performed. This allows a student to remain in a color band without an email option being determined. The color bands are determined weekly and therefore both rapid and sudden drops of academic scores is determined in step 1114 and more continuous decline would be determined in step 1130 when the grades are below the previous color band level.

The email generated in step 1122 may be populated with available timeslots that are sent to the parent or guardian. The teacher may have various timeslots that are utilized and thus a first come, first serve basis may be used to schedule the conferences. The conferences may be scheduled in a virtual or face to face form.

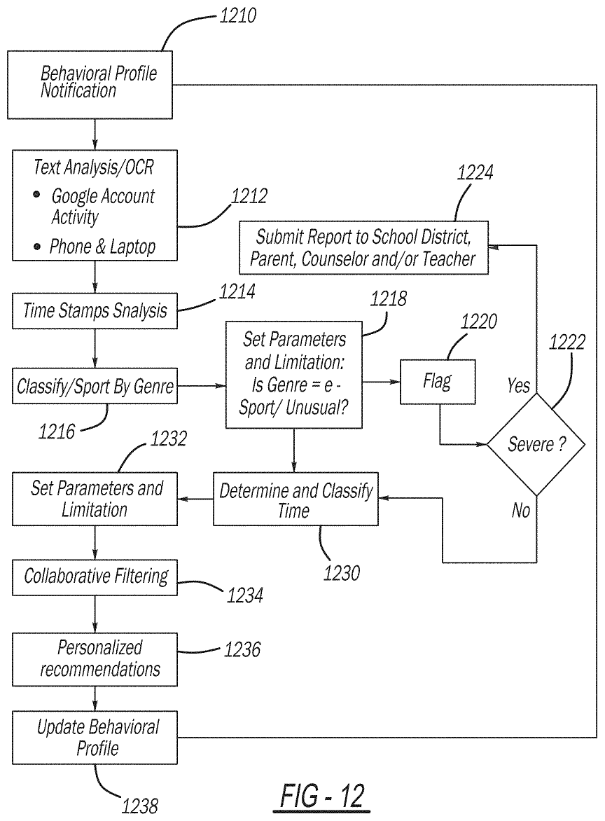

Referring now to FIG. 12, a determination of a behavior performance indicator is set forth. In step 1210, behavioral profile notification is generated in step 1210. In step 1212, the system performs a text analysis and optical character recognition for various activities associated with the student's device, such as search engine activity, including the recordation of services and various inputs into various websites, cellphone activity, such as text, and other searches. Other devices associated with this student may also be queried for various analysis. In step 1214, each of the various determinations of step 1212 may be provided with a time stamp as indicated by the timer 62 of FIG. 1. In step 1216, the genre of the digital footprint such as the various determinations of step 1212 may be provided. Certain types of searching and internet browsing is okay and depending upon the time. For example, non-educational searches during engagement time during school hours is not behavioral sound. Non-educational searches during late night are also troublesome when the student should be asleep and resting for the next day. Unusual searches may be flagged that refer to various types of areas that are not related to educational. The severity of the determinations are determined in step 1218. In step 1218, if the genre of the digital footprint is unusual or related to video games or not education sites and have been engaged in for various times during school hours or during late night, a flag may be set in step 1220. If the conditions indicate a severe performance indicator when compared to a base or previous behavioral performance indicator, step 1224 is performed and a report or behavior alert signal is communicated to the school district, teacher device, counselor device and or parent devices. The classification of step of the data in step 1218 is determined in step 1230. Severe behavior is flagged while other behavior may not be determined as severe is determined and classified in step 1230. In this way, an emotional trigger may be received. The classification may be based upon the student's age, learner type, grade level and other unique user identifier. Various parameters and limitations in step 1232 may be determined. The parameters retrieve programming from various programming sources, counseling sites and the likes and dislikes of the student may be taken into consideration in step 1234. The student's previous reactions or feedback to various recommendations are taken into consideration. Collaborative filtering 1234 may also take place with a student that is willing to provide support to the student in question. Personalized behavior resource recommendation signals are generated in step 1236 based upon whether it is determined that such programming will or is predicted to help the student. Random surveys may also be used to assess the quality of the recommended programming to improve the quality of the service. The behavioral profile of a student is updated in step 1238. Data analytics may determine how the recommended programming is used by the time of engagement and whether the recommendation produced a positive impact or no impact on the behavior indicator, which is color based. The analyzed data is provided to update the user profile in step 1238. This may be performed weekly. After step 1238, the system reprocesses periodically and steps 1210-1238 is performed.

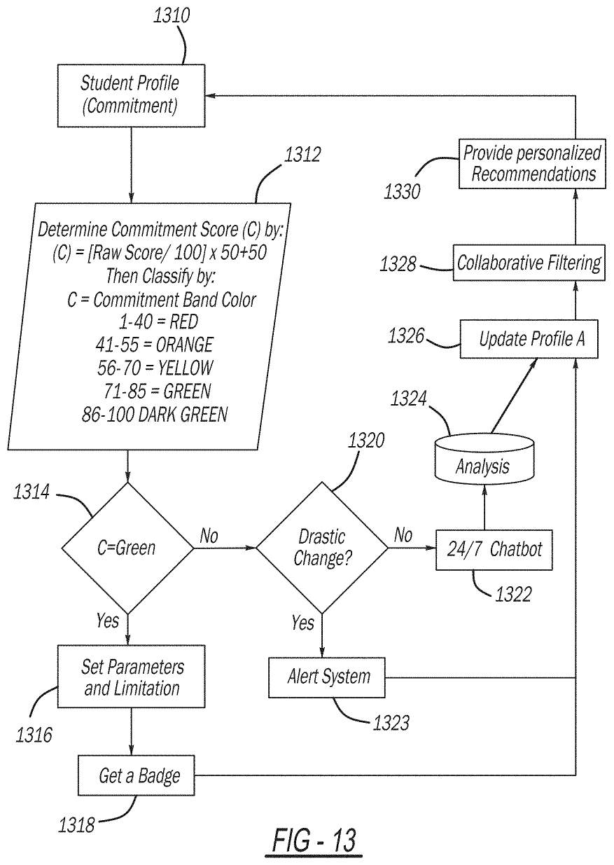

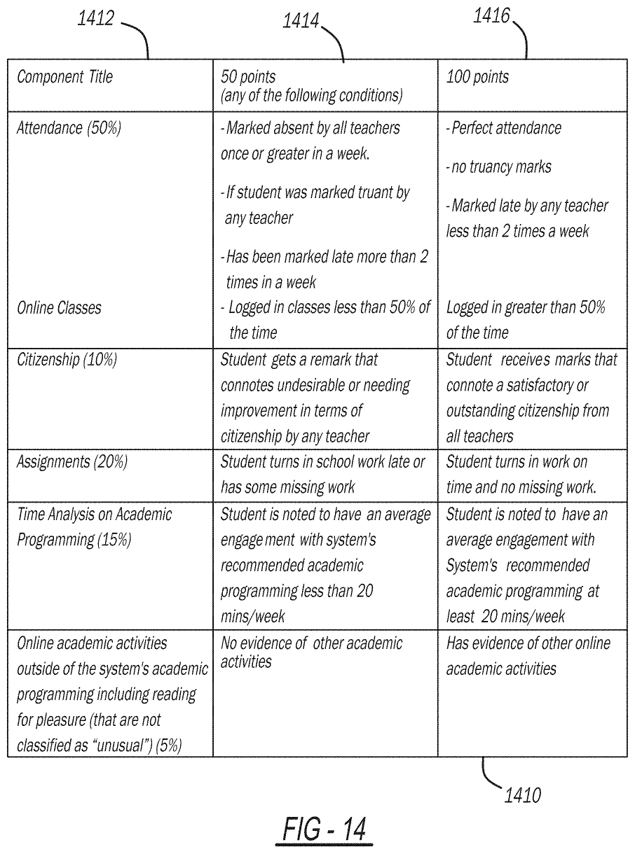

Referring now to FIG. 13, the commitment performance indicator is generated. In step 1310, the student profile and, in particularly, the commitment or previous performance level is obtained. In step 1312, a commitment performance indicator is determined. In this example, a score may be generated and a color band determined for various ranges of the raw score. An example of the score is generated in FIG. 14. Once the color band is determined in step 1312, step 1314 determines whether the color band is green. When the color band is not green, parameters and limitations are set in step 1316. The parameters and limitations are used to obtain a badge in step 1318. The badge may be a performance badge or improvement badge such as those described in FIGS. 9 and 10. After step 1314 determines the color band is not green, step 1320 determines a drastic change has occurred. The color level is a commitment performance indicator that is compared to previous commitment performance indicators or the baseline at the start of a process.

When a drastic change has not occurred or when the change is severe enough, a chatbot is generated in step 1322. Analysis of the chatbot response data is generated in 1324 and an update to the student profiles is performed in step 1326.

Referring back to step 1320, when a drastic change has occurred, the alert system generates a commitment alert signal similar to the other alerts signals described above relative to FIG. 11 is performed in step 1323. Thereafter, the step 1326 is performed. After step 1326, collaborative filtering takes place in step 1328. Collaborative filtering is described in detail above. After step 1328, personalized commitment resource recommendation signals are generated in step 1330. The determination of personalized recommendations was described above. However, the commitment or motivational category is determined in this step. In step 1330, the personalized recommendations similar to those described above but relative to the commitment category are generated. The recommendations provide a database of motivational programming that is sorted to improve the commitment of the student. Metadata may be stored with the personalized recommendations so that the grade level and unique characteristics of the student may be considered and matched when determining the commitment level improvement suggestions. The chatbot in 1322 may analyze the response data provided. The learner type, age and grade level as well as the conversation history data is compared to determine similarly coded programs or applications to provide a way for the student to improve without drastic measures. The programming or applications may be ranked to fit the student commitment profile as described above. Random surveys may also be used to assess the quality of the recommended programming to improve the quality of the service. Collaborative filtering in step 1328 takes into consideration the likes and dislikes of the students in the community as well as the current student. Some communities may generally like or dislike certain types of personalized recommendations. The student profile is updated in step 1310 after the student uses the personalized recommendation. When the student does not use the personalized recommendation, the existence of that is noted in step 1310. It should be noted that the alert system in step 1323 is described above. In addition, an indicator may be provided to explain why the scheduling of a conference is necessary.

Referring now to FIG. 14, a rubric 1410 is illustrated with three columns. The first column 1412 describes the component of the rubric. The second column 1414 provides the amount of points for certain conditions. Column 1416 provides a maximum amount of points for model behavior. The rubric, in this example, provides a percentage or weight for each of the elements in the various rows. In this example, attendance is worth 50%, citizenship 10%, assignments 20% and time analysis on academic programming 15%. Online academic activities outside of the systems academic programming including reading for pleasure may be worth an additional 5%. To earn 50 points, a student has to be marked absent by all teachers once or greater in a week. If the student was marked truant by any teacher or has been marked late more than two times in a week, 50% is provided. For online classes, being logged in less than 50% of the time is also noted. 100 points is achieved when perfect attendance, no truancy or not being marked late by a teacher, less than two times a week is provided. When the student is logged in greater than 50% of the time, 100 points is provided. In the second row, when the student gets a remark that connotes undesirable or needing improvement by a teacher, points are assigned. However, a greater number of points are assigned in the third column 1416 when the student receives marks that connote a satisfactory or outstanding citizenship by all teachers.

With respect to assignments, when the student turns in schoolwork late or has some missing assignments, a lower number of points is assigned versus when a student turns in on-time work.

When the student is noted to have an average engagement with the system's recommended academic programming less than 20 minutes per week, a low number of points is assigned. In the third column, when a student is noted to have an average engagement with the system's recommended academic programming of at least 20 minutes per week, a greater number of points is assigned. The last row corresponds to having no evidence of other academic activities versus having evidence of other online academic activates in column 1416. A greater number of points is assigned to a student that has a greater number of academic activities. The score may be tallied and weighted to determine the ultimate commitment profile indicator. As is illustrated the rubric 1410, both online and in-person classroom commitment may be judged. Online learning may take into consideration the online learning classes such as Google Meet®, Canvas®, Edlio® and the like. A login history may be obtained for the hours that school is in session.

Referring now to FIG. 15, a composite reward system may also be provided. The academic level and commitment level of a student may be rewarded over a long period of time such as at the end of the school year. In step 1510, weekly (or another period) academic performance indicator, a behavior performance indicator, a behavior performance indicator and a commitment performance indicator may all be obtained. In step 1512, the indicators of step 1510 are weighted. In step 1514, all of the students in the system may have steps 1510 and 1514 performed relative to their performance indicators. In step 1516, the performance indicators may be ranked based upon the weighted indicator. Each school district may weigh the various performance indicators differently. However, the performance is tracked throughout the grading period or school year. In step 1518, award recipients are provided based upon school district criteria. For example, the top three students in every grade may receive a special award. At the end of the school year, the top three performers of all time may also be rewarded. These rewards are provided to the students and may be in the form of a scholarship or merchandise. Scholarships may be provided to the student's choice of universities.

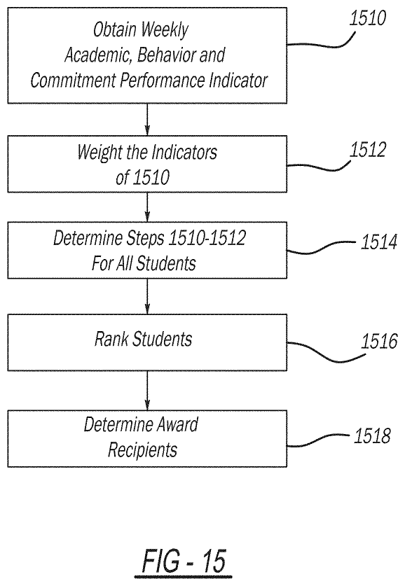

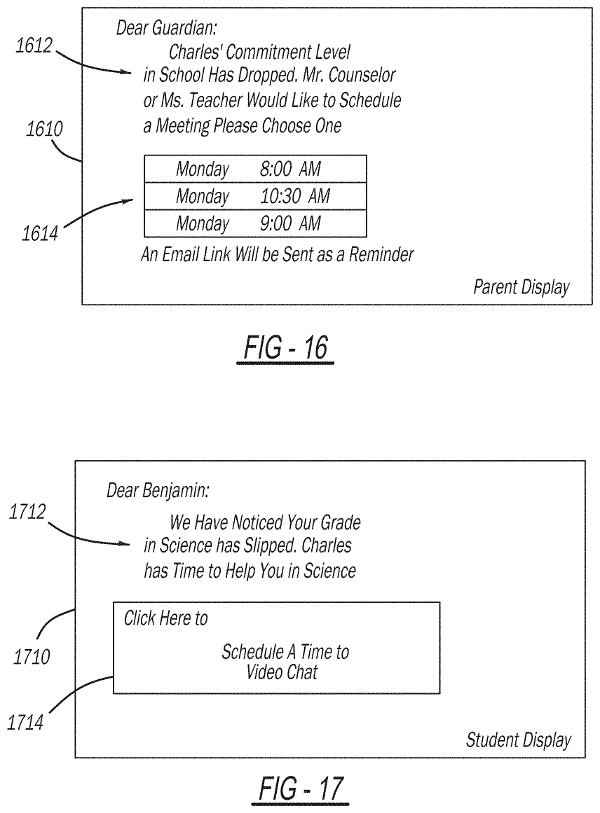

Referring now to FIG. 16, one example of a screen display 1610 for scheduling a conference is set forth. A letter 1612 may be generated as well as numerical times at 1614. By selecting one of the times, links may be provided to save to the calendar or the like.

Referring now to FIG. 17, a screen display 1710 corresponding to a collaboration request signal may be provided. In this example, a letter 1712 may indicate to the student that another student is available to assist. A connector box 1714 may be used to connect the students. An email address or telephone number may be provided in the box. In this example, a video chat link may be provided so that the students may connect and the student needing assistance may be improved.

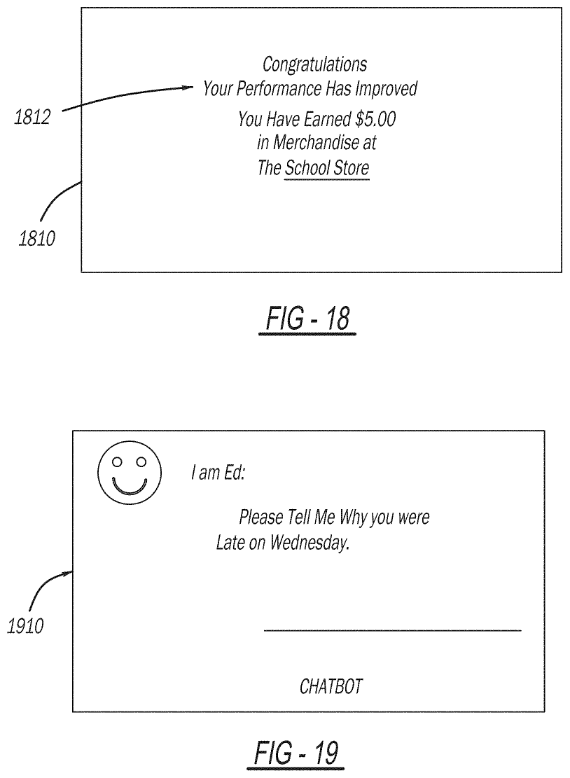

Referring now to FIG. 18, a reward screen 1810 is generated. The reward screen may have a letter 1812 that indicates an amount and the location where the amount may be spent. In this example, the student earned $5 for merchandise at the school store.

Referring now to FIG. 19, a screen display 1910 corresponding to a chatbot is set forth. The chatbot may provide various queries to the student to help remedy the situation and choose a recommendation. In this example, the chatbot has a name “Ed” and generates a query for determining why the student was late on a particular day.

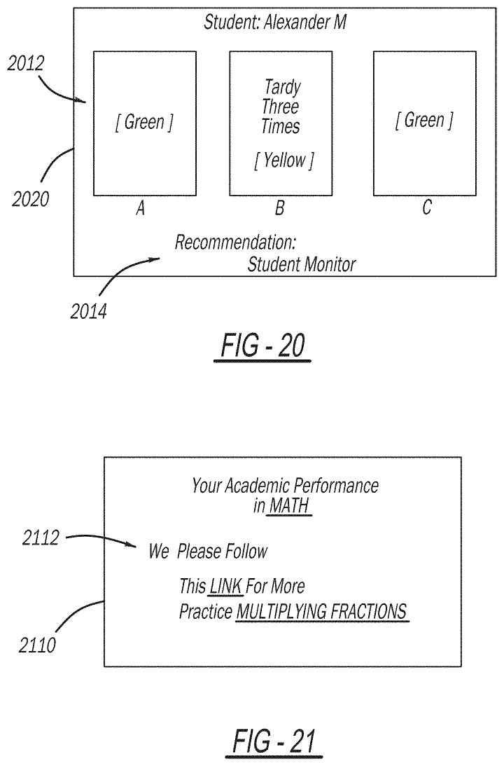

Referring now to FIG. 20, a screen display 2020 corresponding to a display alert is set forth. In this example, the screen display 2020 may be displayed on an administrator or parent website. Screen indicia 2012 are provided for various levels including academic, behavioral and commitment. In this example, the student was tardy three times and the level may be less than green. By providing color, the level of performance may be easily ascertain. A recommendation 2014 that was provided to the student may also be displayed to the administrator or parent. In this example, “student monitor” is provided as a means to help improve the student's behavioral performance.

Referring now to FIG. 21, a screen display 2110 corresponding to an alert for a student is set forth. In this example, a letter 2112 with boxes is used as a template. In this example, a link is provided to a recommendation in math by following a link. Of course, other websites or apps may be provided to the student for obtaining further assistance.

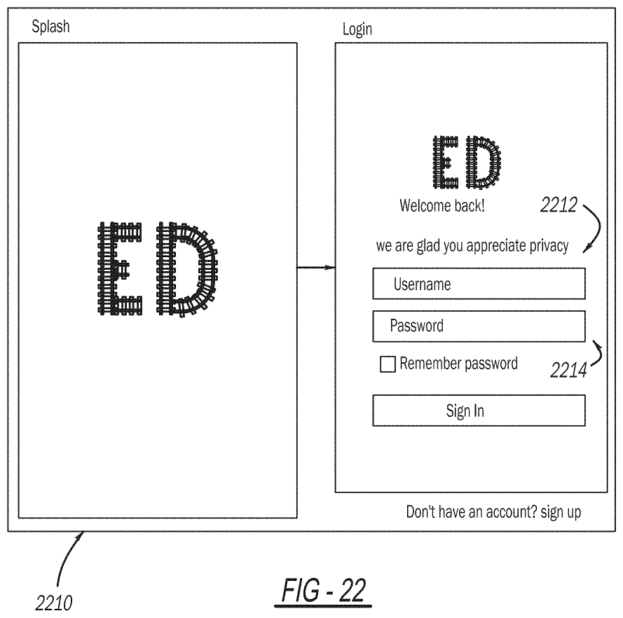

Referring now to FIG. 22, a welcome screen 2210 for the system is set forth. A welcome screen may have a user name location 2212 and a password location 2214. Of course, other ways to log in including fingerprint and face recognition may be provided to the system.

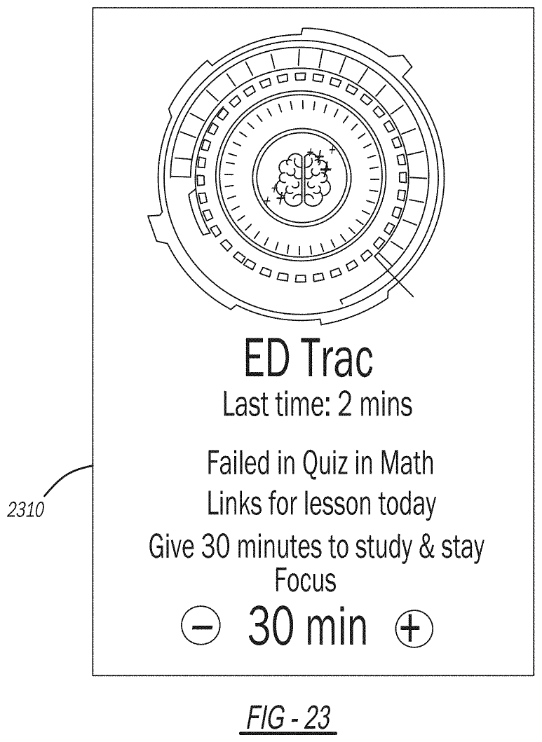

FIG. 23 is another example of a screen display 2310 for displaying a warning screen to the student. The score that causes the academic warning is provided. Words of encouragement may also be provided such as “study for 30 minutes”.

The grouping of students for collaborative work may be performed in groups. More than two students may be joined in a group using a collaboration signal. Grouping students may be performed for all of the academic, behavior and commitment performance indicators indicating a negative performance. The groupings may take place based upon various characteristics such as geographic location, authenticity, age, gender, grade level and the like. High performing student and low performing students may be joined together in a group. The chats and other online inputs are monitored by the system for security purposes. The chats and online activities are analyzed for collaborative filtering purposes to properly identify strategies that may work best for students of certain groups.

Various terms such as indicator, badge, color band and color levels above refer to data in a data signal that is communicated through network.

It should be noted that the system described above is described relative to a microprocessor-based controller 12. As mentioned above, the controller 12 may be distributed over a plurality of servers with a central server 10 indicated for convenience. The server 10 is microprocessor-based and therefore is programmed to perform various functions together with the various inputs, which are provided to the various devices such as the student device 14, the parent device 22 and the various school system devices.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of evaluating a student comprising:
determining an academic performance indicator;
determining a behavioral performance indicator;
determining a commitment performance indicator;
comparing the academic performance indicator to a previous academic performance indicator;
when the step of comparing academic performance corresponds to a positive academic performance, generating an academic badge signal and communicating the academic badge signal to a student device;
when the step of comparing academic performance corresponds to a negative academic performance, communicating an academic resource recommendation signal to the student device and communicating an academic alert signal to at least one of a teacher device and a parent device;
when the behavioral performance indicator corresponds to negative behavioral performance, communicating a report signal to at least one of a teacher device, an administrator device and a counselor device;
comparing the commitment performance indicator to a previous commitment performance indicator;
when the step of comparing the commitment performance indicator corresponds to a positive commitment performance, generating a commitment badge signal and communicating the commitment badge signal to the student device; and
when the step of comparing the commitment performance indicator corresponds to a negative commitment performance, communicating a commitment resource recommendation signal to the student device and a commitment alert signal to a teacher device and a parent device.

2. The method of claim 1 further comprising updating a user profile in response to the academic performance indicator, the behavioral performance indicator and the commitment performance indicator.

3. The method of claim 1 wherein determining the academic performance indicator comprises communicating grade signals and test signals through a network to a central server.

4. The method of claim 1 wherein determining the academic performance indicator comprises determining a plurality of levels.

5. The method of claim 4 wherein the plurality of levels comprise color levels.

6. The method of claim 1 further comprising generating the academic resource recommendation signal for programming based upon learner type.

7. The method of claim 1 further comprising generating the academic resource recommendation signal for programming based upon a student profile.

8. The method of claim 1 further comprising generating the academic resource recommendation signal for programing based upon feedback from a plurality of users.

9. The method of claim 1 wherein generating an academic badge signal comprises generating a performance badge signal and an improvement badge signal.

10. The method of claim 9 further comprising generating a purchase reward signal based upon at least one of the academic badge signal and the improvement badge signal.

11. The method of claim 1 wherein communicating an academic alert signal comprises communicating a conference scheduling signal.

12. The method of claim 1 wherein when the step of comparing academic performance corresponds to a negative academic performance, communicating a collaboration signal to the student device and a second student device of a high performer of a subject matter for linking the student device and the second student device.

13. The method of claim 1 wherein determining a behavior performance indicator comprises determining a digital footprint in response to at least one of email accounts and websites accessed by the student device.

14. The method of claim 13 further comprising classifying the digital footprint by genre.

15. The method of claim 14 wherein determining the negative behavioral performance based on genre of the digital footprint.

16. The method of claim 1 wherein determining a behavior performance indicator comprises determining psychological assessment results corresponding to emotional stability.

17. The method of claim 1 wherein communicating the report signal comprises communicating a conference scheduling signal.

18. The method of claim 1 further comprising communicating a resource recommendation signal based on the negative behavioral performance and a learner type of a student.

19. The method of claim 1 wherein determining the commitment performance indicator comprises determining the commitment performance indicator in response an attendance record communicated to a central server.

20. The method of claim 1 wherein determining the commitment performance indicator comprises determining, the commitment performance indicator in response an assignment on-time record communicated to a central server.

21. The method of claim 1 wherein determining the commitment performance indicator comprises determining a plurality of levels.

22. The method of claim 21 wherein the plurality of levels comprise color levels.

23. The method of claim 1 further comprising generating the commitment resource recommendation signal for programming based upon learner type.

24. The method of claim 1 further comprising generating the commitment resource recommendation signal for programming based upon a student profile.

25. The method of claim 1 further comprising generating the commitment resource recommendation signal for programing based upon feedback from a plurality of users.

26. The method of claim 1 wherein generating a commitment badge signal comprises generating a commitment performance badge signal and a commitment improvement badge signal.

27. The method of claim 26 further comprising generating a purchase reward signal based upon at least one of the commitment performance badge signal and the commitment improvement badge signal.

28. The method of claim 1 wherein communicating a commitment alert signal comprises communicating a conference scheduling signal.

29. The method of claim 1 further comprising determining, at a central server, a composite score based on the academic performance indicator, the behavioral performance indicator and the commitment performance indicator; and generating a screen display in response to the composite score.

30. The method of claim 29 further comprising weighting the academic performance indicator, the behavioral performance indicator, and the performance indicator in the step of determining the composite score.

31. A method of evaluating a student comprising:
determining an academic performance indicator;
determining a behavioral performance indicator;
determining a commitment performance indicator; and
when the academic performance indicator, the behavioral performance indicator or the commitment performance indicator is negative communicating an alert signal to at least one of a teacher device and a parent device.

32. The method of claim 31 wherein communicating a commitment alert signal comprises communicating a conference scheduling signal.

33. The method of claim 31 when the academic performance indicator, the behavioral performance indicator or the commitment performance indicator is positive, communicating a badge signal to a student device.
